(19) United States
(12) Patent Application Publication
(10) Pub. No.: US 2021/0374544 A1
(43) Pub. Date: Dec. 2, 2021

(54) LEVERAGING LAGGING GRADIENTS IN MACHINE-LEARNING MODEL TRAINING

(71) Applicant: Huawei Technologies Co.,Ltd., Shenzhen (CN)

(72) Inventors: Hui Zang, Cupertino, CA (US); Xiaolin Cheng, San Ramon, CA (US)

(73) Assignee: Huawei Technologies Co.,Ltd., Shenzhen (CN)

(21) Appl. No.: 17/445,139

(22) Filed: Aug. 16, 2021

Related U.S. Application Data
(63) Continuation of application No. PCT/US2019/027008, filed on Apr. 11, 2019.

(51) Int. Cl. G06N 3/08

(52) U.S. Cl. CPC G06N 3/08

(57) ABSTRACT

A computer-implemented method for distributed synchronous training of a neural network model includes detecting gradient sets from a plurality of worker machines, each worker machine generating a gradient set in a current iteration of a training data set, and each gradient set of the gradient sets comprising a plurality of gradients. A lagging gradient set from a lagging worker machine is detected. The lagging gradient set is generated by the lagging worker machine in a prior iteration of the training data set. Aggregated gradients are generated based on the gradient sets and the lagging gradient set. The neural network model is updated based on the aggregated gradients.

### CROSS-REFERENCE TO RELATED APPLICATIONS

This application is a continuation of International Application No. PCT/US2019/027008, filed on Apr. 11, 2019, entitled “LEVERAGING LAGGING GRADIENTS IN MACHINE-LEARNING MODEL TRAINING,” the benefit of priority of which is claimed herein, and which application is hereby incorporated herein by reference in its entirety.

### TECHNICAL FIELD

The present disclosure is related to machine-learning model training

### BACKGROUND

With successful applications of deep neural networks, the requirements for network size and data volume are increasing rapidly. Consequently, efficient training of those networks, especially in a distributed training environment, is particularly important.

In a distributed synchronous training environment for deep neural networks, gradient aggregations during the neural network model training are bottlenecked at the slow worker machines. Before updating the model, the parameter server has to wait until gradients from all worker machines are received. Adding backup worker machines can avoid waiting for gradients from slow worker machines in each iteration and can speed up the computation of updated gradients. But lagging gradients from backup worker machines are discarded, which can contribute to wasting computing resources that can be leveraged elsewhere.

### SUMMARY

Various examples are now described to introduce a selection of concepts in a simplified form, which are further described below in the detailed description. The Summary is not intended to identify key or essential features of the claimed subject matter, nor is it intended to be used to limit the scope of the claimed subject matter.

According to a first aspect of the present disclosure, there is provided a computer-implemented method for distributed synchronous training of a neural network model. The method includes detecting gradient sets from a plurality of worker machines. Each worker machine generates a gradient set in a current iteration of a training data set, and each gradient set of the gradient sets includes a plurality of gradients. A lagging gradient set from a lagging worker machine is detected. The lagging gradient set is generated by the lagging worker machine in a prior iteration of the training data set. Aggregated gradients are generated by performing gradient aggregation based on the gradient sets and the lagging gradient set. The neural network model is updated based on the aggregated gradients.

In a first implementation form of the method according to the first aspect as such, the aggregated gradients are averaged to generate an averaged gradient set. A plurality of weights of the neural network model is updated using the averaged gradient set.

In a second implementation form of the method according to the first aspect as such or any preceding implementation form of the first aspect, a lagging gradient set weight for the lagging gradient set is determined. The gradient aggregation is performed using the plurality of gradient sets and the lagging gradient set weight.

In a third implementation form of the method according to the first aspect as such or any preceding implementation form of the first aspect, where the lagging gradient set weight is determined based on an index of the current iteration and an index of the prior iteration.

In a fourth implementation form of the method according to the first aspect as such or any preceding implementation form of the first aspect, where the lagging gradient set weight is 1/(1+Δ), where Δ is a difference between the index of the current iteration and the index of the prior iteration.

In a fifth implementation form of the method according to the first aspect as such or any preceding implementation form of the first aspect, where the lagging gradient set weight is 1/a^{Δ}, where Δ is a difference between the index of the current iteration and the index of the prior iteration and a is an integer greater than 1.

In a sixth implementation form of the method according to the first aspect as such or any preceding implementation form of the first aspect, the gradient aggregation is performed when a number of worker machines of the plurality of worker machines from which gradient sets of the plurality of gradient sets are received reaches a threshold number of worker machines.

In a seventh implementation form of the method according to the first aspect as such or any preceding implementation form of the first aspect, where updating the neural network model includes updating a plurality of weights and biases within the neural network model based on the aggregated gradients.

In an eighth implementation form of the method according to the first aspect as such or any preceding implementation form of the first aspect, the plurality of gradient sets are received from the corresponding plurality of worker machines via corresponding push operations, subsequent to completion of forward compute and backward compute operations at each worker machine of the plurality of worker machines during the current iteration.

According to a second aspect of the present disclosure, there is provided a distributed synchronous training system for training a neural network model, including a memory that stores instructions and one or more processors in communication with the memory. The one or more processors execute the instructions to detect gradient sets from a plurality of worker machines. Each worker machine generates a gradient set in a current iteration of a training data set, and each gradient set of the gradient sets includes a plurality of gradients. A lagging gradient set from a lagging worker machine is detected. The lagging gradient set is generated by the lagging worker machine in a prior iteration of the training data set. Aggregated gradients are generated by performing gradient aggregation based on the gradient sets and the lagging gradient set. The neural network model is updated based on the aggregated gradients.

In a first implementation form of the distributed synchronous training system according to the second aspect as such, the aggregated gradients are averaged to generate an averaged gradient set. A plurality of weights of the neural network model is updated using the averaged gradient set.

In a second implementation form of the distributed synchronous training system according to the second aspect as such or any preceding implementation form of the second aspect, a lagging gradient set weight for the lagging gradient set is determined. The gradient aggregation is performed using the plurality of gradient sets and the lagging gradient set weight.

In a third implementation form of the distributed synchronous training system according to the second aspect as such or any preceding implementation form of the second aspect, where the lagging gradient set weight is determined based on an index of the current iteration and an index of the prior iteration.

In a fourth implementation form of the distributed synchronous training system according to the second aspect as such or any preceding implementation form of the second aspect, where the lagging gradient set weight is 1/(1+Δ), where Δ is a difference between the index of the current iteration and the index of the prior iteration.

In a fifth implementation form of the distributed synchronous training system according to the second aspect as such or any preceding implementation form of the second aspect, where the lagging gradient set weight is 1/α^{Δ}, where Δ is a difference between the index of the current iteration and the index of the prior iteration, and a is an integer greater than 1.

In a sixth implementation form of the distributed synchronous training system according to the second aspect as such or any preceding implementation form of the second aspect, the gradient aggregation is performed when a number of worker machines of the plurality of worker machines from which gradient sets of the plurality of gradient sets are received reaches a threshold number of worker machines.

In a seventh implementation form of the distributed synchronous training system according to the second aspect as such or any preceding implementation form of the second aspect, where to update the neural network model, the one or more processors execute the instructions to update a plurality of weights and biases within the neural network model based on the aggregated gradients.

According to a third aspect of the present disclosure, there is provided a non-transitory computer-readable medium storing instructions for training a neural network model, that when executed by one or more processors, cause the one or more processors to perform operations. The operations include detecting gradient sets from a plurality of worker machines. Each worker machine generates a gradient set in a current iteration of a training data set. Each gradient set of the gradient sets includes a plurality of gradients. A lagging gradient set from a lagging worker machine is detected. The lagging gradient set is generated by the lagging worker machine in a prior iteration of the training data set. Aggregated gradients are generated by performing gradient aggregation based on the gradient sets and the lagging gradient set. The neural network model is updated based on the aggregated gradients.

In a first implementation form of the non-transitory computer-readable medium according to the third aspect as such, the aggregated gradients are averaged to generate an averaged gradient set. A plurality of weights of the neural network model is updated using the averaged gradient set.

In a second implementation form of the non-transitory computer-readable medium according to the third aspect as such or any preceding implementation form of the third aspect, a lagging gradient set weight for the lagging gradient set is determined. The gradient aggregation is performed using the plurality of gradient sets and the lagging gradient set weight.

Any of the foregoing examples may be combined with any one or more of the other foregoing examples to create a new embodiment within the scope of the present disclosure.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 is a block diagram illustrating the training of a deep learning (DL) program using a DL training architecture (DLTA), according to some example embodiments.

FIG. 2 is a diagram illustrating the generation of a trained DL program using a neural network model trained within a DLTA, according to some example embodiments.

FIG. 3 is a diagram illustrating a DLTA for distributed synchronous training of a neural network model using a plurality of worker machines that timely report gradients to a parameter server, according to some example embodiments.

FIG. 4 is a diagram illustrating an example processing flow that can be performed by worker machines and a parameter server within the DLTA of FIG. 3, according to some example embodiments.

FIG. 5 is a diagram illustrating a DLTA for distributed synchronous training of a neural network model using a parameter server that performs gradient aggregation using lagging gradients, according to some example embodiments.

FIG. 6 illustrates a flowchart of a method that can be performed by a parameter server within the DLTA of FIG. 5, according to some example embodiments.

FIG. 7 illustrates a flowchart of a method that can be performed by a worker within the DLTA of FIG. 5, according to some example embodiments.

FIG. 8 is a graph illustrating training losses associated with DLTAs that perform gradient aggregation with or without taking into account lagging gradients.

FIG. 9 is a graph illustrating validation accuracy associated with DLTAs that perform gradient aggregation with or without taking into account lagging gradients.

FIG. 10 is a flowchart of a method for distributed synchronous training of a neural network model within a DLTA, according to some example embodiments.

FIG. 11 is a block diagram illustrating a representative software architecture, which may be used in conjunction with various device hardware described herein, according to some example embodiments.

FIG. 12 is a block diagram illustrating circuitry for a device that implements algorithms and performs methods, according to some example embodiments.

### DETAILED DESCRIPTION

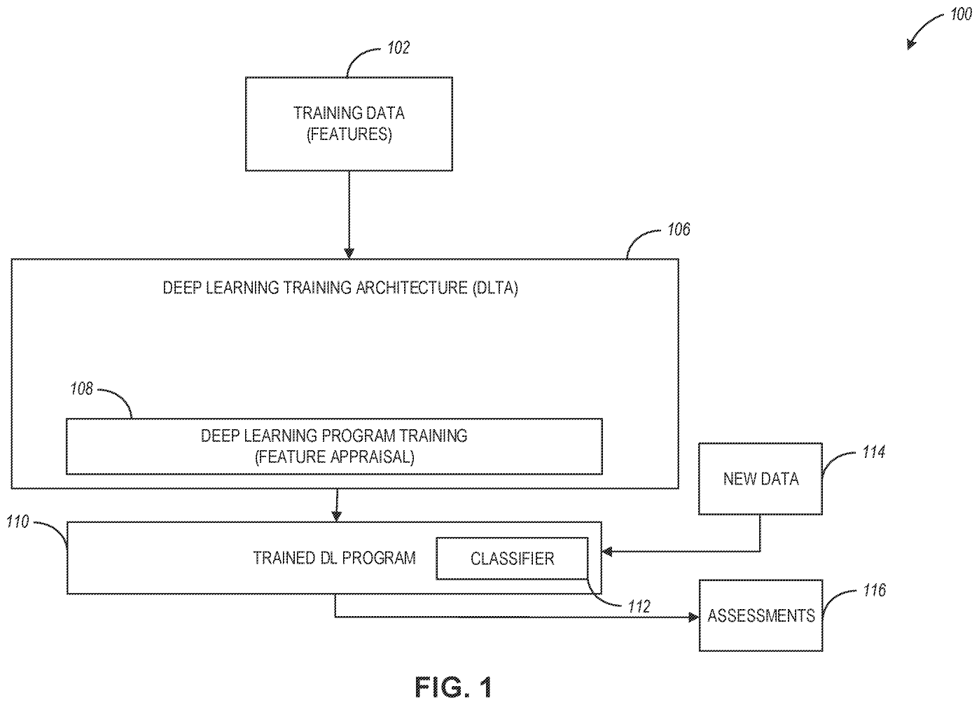

It should be understood at the outset that although an illustrative implementation of one or more embodiments is provided below, the disclosed systems and/or methods described with respect to FIGS. 1-12 may be implemented using any number of techniques, whether currently known or not yet in existence. The disclosure should in no way be limited to the illustrative implementations, drawings, and techniques illustrated below, including the exemplary designs and implementations illustrated and described herein, but may be modified within the scope of the appended claims along with their full scope of equivalents.

In the following description, reference is made to the accompanying drawings that form a part hereof, and in which are shown, by way of illustration, specific embodiments which may be practiced. These embodiments are described in sufficient detail to enable those skilled in the art to practice the inventive subject matter, and it is to be understood that other embodiments may be utilized, and that structural, logical, and electrical changes may be made without departing from the scope of the present disclosure. The following description of example embodiments is, therefore, not to be taken in a limiting sense, and the scope of the present disclosure is defined by the appended claims.

As used herein, the term “worker” refers to a worker machine that is part of a DLTA together with other worker machines, with all worker machines being coupled to a parameter server of the DLTA.

As used in connection with machine-learning networks and architectures, the terms “parameters” and “weights” are interchangeable and refer to the variables in a machine-learning model whose values are updated during each iteration by a certain optimization algorithm using gradients (also referred to as a gradient set) computed from a backward computation. Each parameter/weight in a machine-learning network is associated with a gradient.

As used herein, the term “gradient” indicates the derivative of a loss function with respect to a parameter/weight, with each worker machine generating a plurality of gradients (or a gradient set) at the end of a backward computation. Gradients can be exchanged between the worker machines or can be forwarded to a parameter server, which can perform gradient aggregation, averaging, and gradient updates (e.g., gradient synchronization). As used herein, the terms “worker” and “worker machine” are interchangeable.

As used herein, the terms “forward computation” and “backward computation” refer to computations performed in connection with the training of a neural network model (or another type of model). The computations performed in a current iteration during forward and backward computations modify weights based on results from prior iterations (e.g., based on gradients generated by worker machines at a conclusion of a prior backward computation). In this regard, during a backward computation, a model can output gradients (i.e., a gradient set), which can be used for updating weights during subsequent forward and backward computations.

Known techniques for configuring deep learning training architectures (DLTAs) do not use lagging gradients, and such gradients are discarded. The term “lagging gradient” refers to a gradient reported by a worker machine during a current iteration but the gradient has been determined at a conclusion of a prior iteration (or later). In this regard, potential information from the lagging gradients is lost and it cannot be leveraged for updating neural network model parameters and improving the neural network model performance during a current iteration of a training data set.

Techniques disclosed herein use the lagging gradients efficiently to speed up the training process and improve the neural network training performance. More specifically, when aggregating gradients in a current iteration within a DLTA, adding gradients of previous iterations from backup worker machines may help generate a better direction for updating the neural network model parameters. Since the lagging gradients contain information about particular optimization landscapes from the slow worker(s) during prior iterations, using such lagging gradients by a DLTA parameter server in a subsequent iteration can help direct parameter updating for the neural network model more efficiently.

The present disclosure is related to machine-learning model training. Some aspects relate to improving the performance of training deep neural networks in a distributed synchronous setting with backup workers.

Other aspects relate to leveraging lagging gradients in a distributed synchronous training architecture, such as a deep learning training architecture (DLTA). Using techniques disclosed herein, lagging gradients from slow workers (i.e., workers that are lagging with their data processing and are not able to provide gradients in a current iteration) are received and leveraged by the parameter server in a current iteration. In some aspects, weights are added for the lagging gradients when computing the gradient aggregation and gradient averages, to reflect their importance when aggregating gradients during the current iteration. In this regard, the granularity of usage of the lagging gradients can be tunable via the weights used for weighing such gradients. With the additional information gained from using the lagging gradients, the neural network model training process within a DLTA converges faster. Additionally, within the same amount of model training time, the testing accuracy is higher than the prior art approach of discarding the lagging gradients.

FIG. 1 is a block diagram 100 illustrating the training and use of a deep learning (DL) program 110 using a DL training architecture (DLTA), according to some example embodiments. In some example embodiments, machine-learning programs (MLPs), including deep learning programs, also collectively referred to as machine-learning algorithms or tools, are utilized to perform operations associated with correlating data or other artificial intelligence (AI)-based functions.

As illustrated in FIG. 1, deep learning program training 108 can be performed within the deep-learning training architecture (DLTA) 106 based on training data 102 (which can include features). During the deep learning program training 108, features from the training data 102 can be assessed for purposes of further training of the DL program. The DL program training 108 results in a trained DL program 110 which can include one or more classifiers 112 that can be used to provide assessments 116 based on new data 114.

Deep learning is part of machine learning, which is a field of study that gives computers the ability to learn without being explicitly programmed. Machine learning explores the study and construction of algorithms, also referred to herein as tools, that may learn from existing data, correlate data, and make predictions about new data. Such machine-learning tools operate by building a model from example training data (e.g., the training data 102) to make data-driven predictions or decisions expressed as outputs or assessments 116. Although example embodiments are presented with respect to a few machine-learning tools (e.g., a deep learning training architecture), the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used during the program training process 108 (e.g., for correlating the training data 102).

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). In some embodiments, the DLTA 106 can be configured to use machine-learning algorithms that utilize the training data 102 to find correlations among identified features that affect the outcome.

The machine-learning algorithms utilize features from the training data 102 for analyzing the new data 114 to generate the assessments 116. The features include individual measurable properties of a phenomenon being observed and used for training the ML program. The concept of a feature is related to that of an explanatory variable used in statistical techniques such as linear regression. Choosing informative, discriminating, and independent features is important for the effective operation of the MLP in pattern recognition, classification, and regression. Features may be of different types, such as numeric features, strings, and graphs. In some aspects, training data can be of different types, with the features being numeric, for use by a computing device.

In some aspects, the features in the training data 102 used during the DL program training 108 can include one or more of the following: sensor data from a plurality of sensors (e.g., audio, motion, image sensors); actuator event data from a plurality of actuators (e.g., wireless switches or other actuators); external source information from a plurality of external sources; timer data associated with the sensor state data (e.g., time sensor data is obtained), the actuator event data, or the external information source data; user communications information; user data; user behavior data, and so forth.

The machine-learning algorithms utilize the training data 102 to find correlations among the identified features that affect the outcome of assessments 116. In some example embodiments, the training data 102 includes labeled data, which is known data for one or more identified features and one or more outcomes. With the training data 102 (which can include the identified features), the DL program is trained at operation 108 within the DLTA 106. The result of the training is the trained DL program 110. When the DL program 110 is used to perform an assessment, new data 114 is provided as an input to the trained DL program 110, and the DL program 110 generates the assessments 116 as an output.

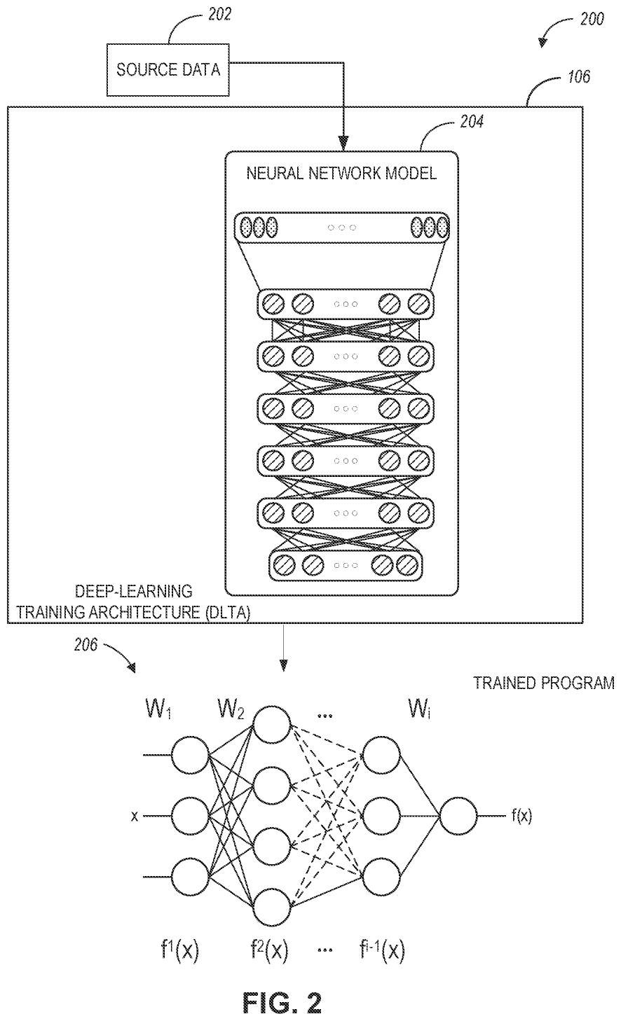

FIG. 2 is a diagram 200 illustrating the generation of a trained DL program 206 using a neural network model 204 trained within the DLTA 106, according to some example embodiments. Referring to FIG. 2, source data 202 can be analyzed by a neural network model 204 (or another type of a machine-learning algorithm or technique) to generate the trained DL program 206 (which can be the same as the trained DL program 110). The source data 202 can include a training set of data, such as the training data 102, including data identified by one or more features.

Machine-learning techniques train models to accurately make predictions on data fed into the models (e.g., what was said by a user in a given utterance; whether a noun is a person, place, or thing; what the weather will be like tomorrow). During a learning phase, the models are developed against a training dataset of inputs to optimize the models to correctly predict the output for a given input. Generally, the learning phase may be supervised, semi-supervised, or unsupervised; indicating a decreasing level to which the “correct” outputs are provided in correspondence to the training inputs. In a supervised learning phase, all of the outputs are provided to the model and the model is directed to develop a general rule or algorithm that maps the input to the output. In contrast, in an unsupervised learning phase, the desired output is not provided for the inputs so that the model may develop its own rules to discover relationships within the training dataset. In a semi-supervised learning phase, an incompletely labeled training set is provided, with some of the outputs known and some unknown for the training dataset.

Models may be run against a training dataset for several epochs, in which the training dataset is repeatedly fed into the model to refine its results (i.e., the entire dataset is processed during an epoch). During an iteration, the model (e.g., a neural network model or another type of machine-learning model) is run against a mini-batch (or a portion) of the entire dataset. In a supervised learning phase, a model is developed to predict the output for a given set of inputs (e.g., source data 202) and is evaluated over several epochs to more reliably provide the output that is specified as corresponding to the given input for the greatest number of inputs for the training dataset. In another example, for an unsupervised learning phase, a model is developed to cluster the dataset into n groups and is evaluated over several epochs as to how consistently it places a given input into a given group and how reliably it produces the n desired clusters across each epoch.

Once an epoch is run, the models are evaluated, and the values of their variables (e.g., weights, biases, or other parameters) are adjusted to attempt to better refine the model iteratively. In various aspects, the evaluations are biased against false negatives, biased against false positives, or evenly biased with respect to the overall accuracy of the model. The values may be adjusted in several ways depending on the machine-learning technique used. For example, in a genetic or evolutionary algorithm, the values for the models that are most successful in predicting the desired outputs are used to develop values for models to use during the subsequent epoch, which may include random variation/mutation to provide additional data points.

Each model develops a rule or algorithm over several epochs by varying the values of one or more variables affecting the inputs to more closely map to the desired result, but as the training dataset may be varied, and is preferably very large, perfect accuracy and precision may not be achievable. Several epochs that make up a learning phase, therefore, may be set as a given number of trials or a fixed time/computing budget or may be terminated before that number/budget is reached when the accuracy of a given model is high enough or low enough or an accuracy plateau has been reached. For example, if the training phase is designed to run n epochs and produce a model with at least 95% accuracy, and such a model is produced before the n^{th} epoch, the learning phase may end early and use the produced model satisfying the end-goal accuracy threshold. Similarly, if a given model is inaccurate enough to satisfy a random chance threshold (e.g., the model is only 55% accurate in determining true/false outputs for given inputs), the learning phase for that model may be terminated early, although other models in the learning phase may continue training. Similarly, when a given model continues to provide similar accuracy or vacillate in its results across multiple epochs—having reached a performance plateau—the learning phase for the given model may terminate before the epoch number/computing budget is reached.

Once the learning phase is complete, the models are finalized. In some example embodiments, models that are finalized are evaluated against testing criteria. In a first example, a testing dataset that includes known outputs for its inputs is fed into the finalized models to determine the accuracy of the model in handling data that has not been trained on. In a second example, a false positive rate or false-negative rate may be used to evaluate the models after finalization. In a third example, a delineation between data clusters in each model is used to select a model that produces the clearest bounds for its clusters of data.

In some example embodiments, the DL program 206 is trained by a neural network 204 (e.g., deep learning, deep convolutional, or recurrent neural network) which comprises a series of “neurons,” such as Long Short Term Memory (LSTM) nodes, arranged into a network. A neuron is an architectural element used in data processing and artificial intelligence, particularly machine learning, that includes memory that may determine when to “remember” and when to “forget” values held in that memory based on the weights of inputs provided to the given neuron. Each of the neurons used herein is configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance is related to one another.

For example, an LSTM serving as a neuron includes several gates to handle input vectors (e.g., phonemes from an utterance), a memory cell, and an output vector (e.g., contextual representation). The input gate and output gate control the information flowing into and out of the memory cell, respectively, whereas forget gates optionally remove information from the memory cell based on the inputs from linked cells earlier in the neural network. Weights and bias vectors for the various gates are adjusted throughout a training phase, and once the training phase is complete, those weights and biases are finalized for normal operation. One of skill in the art will appreciate that neurons and neural networks may be constructed programmatically (e.g., via software instructions) or via specialized hardware linking each neuron to form the neural network.

Neural networks utilize features for analyzing the data to generate assessments (e.g., recognize units of speech). A feature is an individual measurable property of a phenomenon being observed. The concept of the feature is related to that of an explanatory variable used in statistical techniques such as linear regression. Further, deep features represent the output of nodes in hidden layers of the deep neural network.

A neural network (e.g., the neural network 204), sometimes referred to as an artificial neural network or a neural network model, is a computing system based on consideration of biological neural networks of animal brains. Such systems progressively improve performance, which is referred to as learning, to perform tasks, typically without task-specific programming For example, in image recognition, a neural network may be taught to identify images that contain an object by analyzing example images that have been tagged with a name for the object and, having learned the object and name, may use the analytic results to identify the object in untagged images. A neural network is based on a collection of connected units called neurons, where each connection, called a synapse, between neurons, can transmit a unidirectional signal with an activating strength that varies with the strength of the connection. The receiving neuron can activate and propagate a signal to downstream neurons connected to it, typically based on whether the combined incoming signals, which are from potentially many transmitting neurons, are of sufficient strength, where strength is a parameter.

A deep neural network (DNN) is a stacked neural network, which is composed of multiple layers. The layers are composed of nodes, which are locations where computation occurs, loosely patterned on a neuron in the human brain, which fires when it encounters sufficient stimuli. A node combines input from the data with a set of coefficients, or weights, that either amplify or dampen that input, which assigns significance to inputs for the task the algorithm is trying to learn. These input-weight products are summed, and the sum is passed through what is called a node's activation function, to determine whether and to what extent that signal progresses further through the network to affect the outcome. A DNN uses a cascade of many layers of non-linear processing units for feature extraction and transformation. Each successive layer uses the output from the previous layer as input. Higher-level features are derived from lower-level features to form a hierarchical representation. The layers following the input layer may be convolution layers that produce feature maps that are filtering results of the inputs and are used by the next convolution layer.

In the training of a DNN architecture, a regression, which is structured as a set of statistical processes for estimating the relationships among variables, can include the minimization of a cost function. The cost function may be implemented as a function to return a number representing how well the neural network performed in mapping training examples to correct output. In training, if the cost function value is not within a predetermined range, based on the known training images, backpropagation is used, where backpropagation is a common method of training artificial neural networks that are used with an optimization method such as stochastic gradient descent (SGD) method.

The use of backpropagation (or backward computation) can include propagation and weight update. When an input is presented to the neural network, it is propagated forward through the neural network, layer by layer, until it reaches the output layer. The output of the neural network is then compared to the desired output, using the cost function, and an error value is calculated for each of the nodes in the output layer. The error values are propagated backward, starting from the output, until each node has an associated error value which roughly represents its contribution to the original output. Backpropagation can use these error values to calculate the gradients of the cost function with respect to the weights in the neural network. The calculated gradients (or a gradient set) are fed to the selected optimization method to update the weights to attempt to minimize the cost function.

Even though the training architecture 106 is referred to as a deep learning training architecture using a neural network model (and the program that is trained is referred to as a trained deep learning program, such as the trained DL program 110 or 206), the disclosure is not limited in this regard and other types of machine-learning training architectures may also be used for model training, using the techniques disclosed herein.

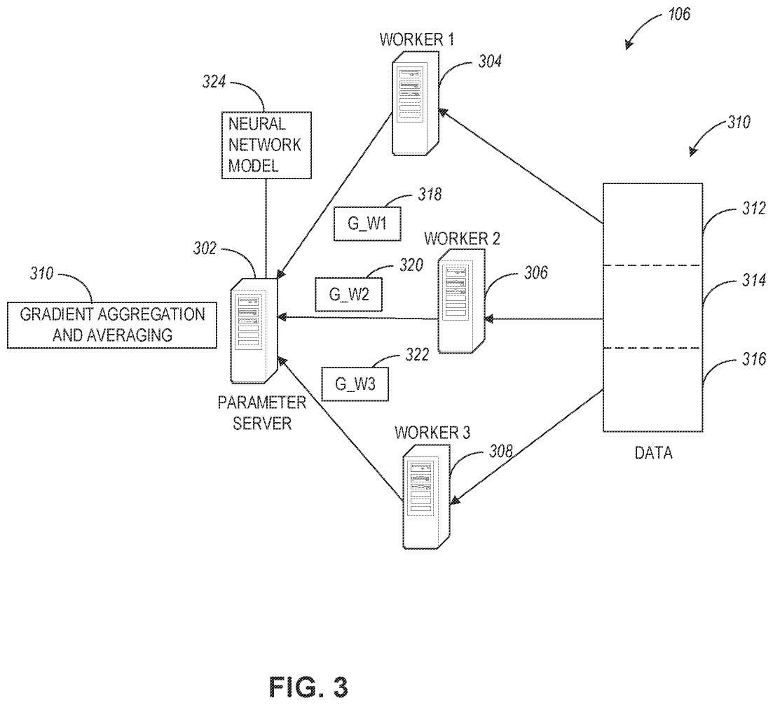

FIG. 3 is a diagram illustrating an example DLTA 106 for distributed synchronous training of a neural network model using a plurality of workers that timely report gradients to a parameter server, according to some example embodiments. Timely reports of gradients in some examples comprise a worker machine reporting a result gradient during a current iteration of a training data set. This includes reporting at or before an end of the current iteration. Referring to FIG. 3, the DLTA 106 includes a parameter server 302 and workers 304, 306, and 308. The workers 304, 306, and 308 comprise computing devices for generating, receiving, or otherwise obtaining gradient sets during the training of the neural network model. The DLTA 106 can use data parallelism where training data 310 is split into corresponding data portions 312, 314, 316 for use by the workers 304, 306, and 308, respectively.

In operation, after each iteration of their corresponding data portion, each of the workers can report updated gradients to the parameter server 302. For example, workers 304, 306, and 308 perform the first iteration on the data portions 312, 314, and 316 respectively, to generate gradients (also referred to as gradient sets) 318, 320, and 322 at the end of the first iteration of the data. The gradients 318, 320, and 322 are communicated (e.g., via a push communication) by the workers 304, 306, and 308 respectively, to the parameter server 302. The parameter server 302 then performs gradient aggregation and averaging 310 using the gradients 318, 320, and 322 at the end of the first iteration, to obtain an averaged gradient set. As a result of the gradient aggregation and averaging 310, the parameter server 302 updates the parameters of the neural network model 324 using the averaged gradient set. The updated neural network model 324 (or the updated parameters) is then communicated to each of the workers 304, 306, and 308, or is made available by the parameter server 302 when such information is requested by each worker. Even though the DLTA 106 is illustrated as including only three workers, the disclosure is not limited in this regard and a different number of workers can be utilized within the DLTA.

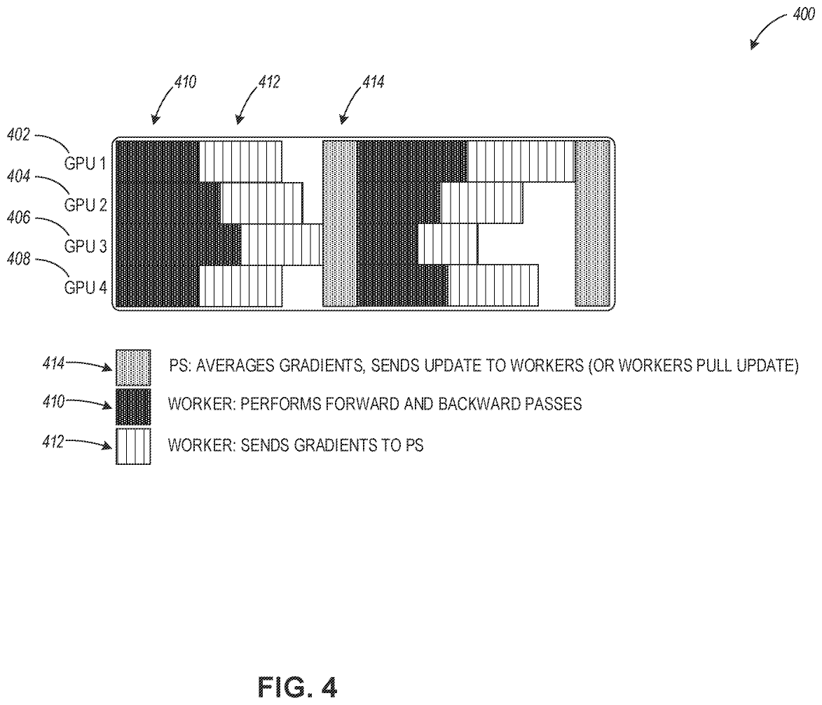

FIG. 4 is a diagram 400 illustrating an example processing flow that can be performed by workers and a parameter server within the DLTA 106 of FIG. 3, according to some example embodiments. Referring to FIG. 4, each of illustrated processors (e.g., graphics processing units or GPUs) 402, 404, 406, and 408 are representative of a corresponding worker within the DLTA 106. For example, the GPUs 404, 406, and 408 can correspond to the workers 304, 306, 308, respectively.

In operation, a worker performs a forward pass and a backward pass using its corresponding data portion at operation 410. At operation 412, each of the workers communicates its gradients to the parameter server. At operation 414, after each of the workers has communicated its gradients, the parameter server averages the gradients, averages the gradients to generate an averaged gradient set, updates the model using the averaged gradient set, and communicates the updated model to the workers (or makes the updated model available so the workers can request it from the parameter server).

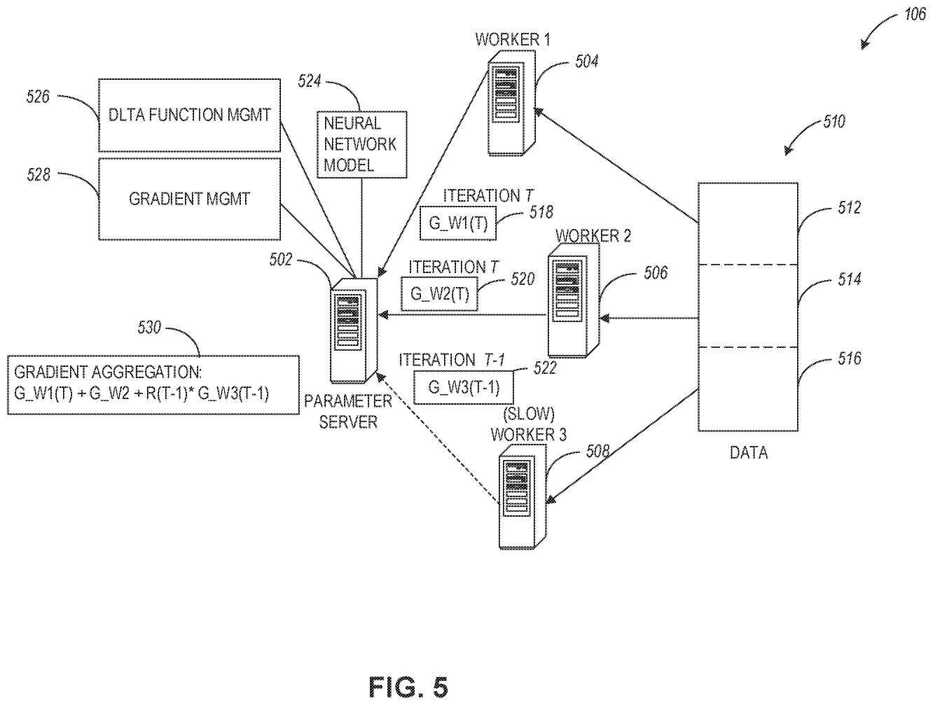

FIG. 5 is a diagram illustrating a DLTA for distributed synchronous training of a neural network model using a parameter server that performs gradient aggregation using lagging gradients, according to some example embodiments. Referring to FIG. 5, the DLTA 106 includes a parameter server 502 and workers 504, 506, and 508. The DLTA 106 can use data parallelism where training data 510 is split into corresponding training data portions 512, 514, and 516 for use by the workers 504, 506, and 508, respectively.

In operation, after each iteration of their corresponding data portion, each of the workers can report updated gradients to the parameter server 502. For example, the workers 504 and 506 perform an iteration #t (i.e., iteration with index t) on the training data portions 512 and 514 respectively, to generate gradient sets G_W1(t) 518 and G_W2(t) 520 at the end of the current iteration #t of the training data portions 512 and 514. As illustrated in FIG. 5, worker 508 is a slow worker that is not able to generate a gradient set during the current iteration #t. However, by the time workers 504 and 506 complete the current iteration #t, worker 508 can complete a prior iteration with index (t−1), generating gradient set G_W3(t−1) 522.

The gradient sets 518 and 520 (from the current iteration #t) and the gradient set 522 (from the prior iteration #(t−1)) are communicated (e.g., via a push communication) by the workers 504, 506, and 508 respectively, to the parameter server 502. The parameter server 502 then performs gradient aggregation and averaging operation 530 using the gradient sets 518 and 520 from the current iteration (t) as well as the gradient set 522 from the prior iteration (t−1). As a result of the gradient aggregation and averaging operation 530, the parameter server 502 generates an averaged gradient set and updates the parameters of the neural network model 524 using the averaged gradient set. The updated neural network model 524 (or the updated parameters) is communicated to each of the workers 504, 506, and 508, or is made available by the parameter server 502 for a pull communication initiated by each worker.

In some aspects, the DLTA 106 can further include a DLTA function management module 526 and a gradient management module 528. The DLTA function management module 526 may comprise suitable circuitry, logic, interfaces, and/or code and is configured to perform functionalities associated with training the neural network model 524 as well as managing communications between the parameter server 502 and the workers 504, 506, and 508. For example, the DLTA function management module 526 is configured to select a machine-learning model, such as the neural network model 524, for training within the DLTA 106. Additionally, the DLTA function management module 526 is configured to manage communications between the parameter server and the workers, including communicating the updated neural network model (or updated neural network model parameters) to the workers or notifying the workers that such updated parameters or an updated model are available for communication via a pull operation.

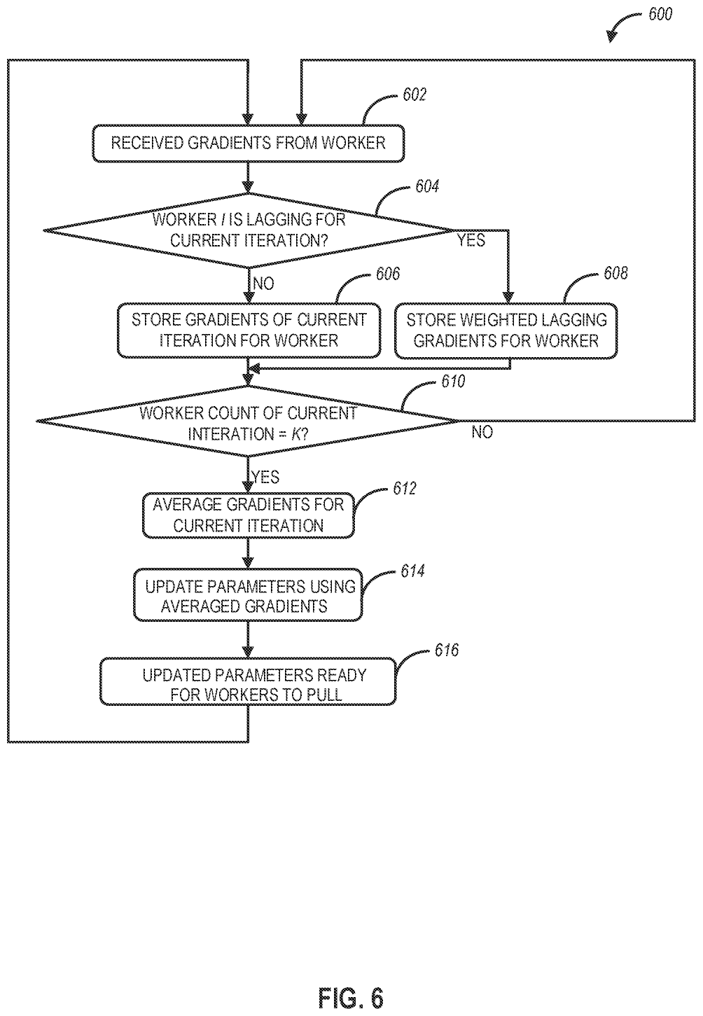

In some aspects, the DLTA function management module 526 also configures a threshold number of workers (e.g., K number of workers, as used in connection with FIG. 6) for purposes of determining whether to proceed with the determination of the averaged gradient set for a current iteration. More specifically, the parameter server can be configured to wait until it receives gradients from K number of workers within the current iteration before proceeding to perform the gradient aggregation and averaging for updating the model parameters. Alternatively, the DLTA function management module 526 can configure a timer that can start after a prior update to the model is (or has been) communicated to the workers and can expire at a predetermined time that can be considered a cut off time for receiving gradients from the available workers. For example, if at the expiration of such timer the parameter server has received the gradient set 518 from a current iteration and the gradient set 522 from a prior iteration, but not yet the gradient set 520, then the parameter server can use only the gradient sets 518 and 522 during the gradient aggregation and averaging operation 530.

The gradient management module 528 may comprise suitable circuitry, logic, interfaces, and/or code and is configured to perform the gradient aggregation and averaging operation 530. In some aspects, the gradient management module 528 configures a lagging gradient set weight that can be applied to any lagging gradient set, such as gradient set 522, to obtain at least one weighted version of a lagging gradient set. As used herein, the term “lagging gradient” refers to a gradient reported by a worker during a current iteration but the gradient has been determined at (or after) a conclusion of a prior iteration. For example and as illustrated in FIG. 5, the gradient management module 528 can assign a weight r(t−1), which can be applied to the gradient set 522 during the gradient aggregation and averaging operation 530. More specifically, gradient aggregation of the gradient sets 518, 520, and 522 can be performed by the parameter server 502 as follows: G_W1(t)+G_W2+r(t−1)*G_W3(t−1), where r(t−1) is the assigned weight. After the gradient aggregation is performed, gradient averaging can be performed based on the aggregated gradients (e.g., by dividing each gradient of the aggregated gradients by the total number of workers to obtain an averaged gradient set for updating the model or by using other averaging techniques).

In some aspects, the gradient management module 528 can use different techniques for discounting the lagging gradients by applying weights to lagging gradient sets. In one aspect, a wait for discounting a lagging gradient set can be calculated as r=1/(1+Δ), where “/” indicates division and Δ is the difference between the current iteration index and the iteration index of the lagging gradient set (e.g., t−(t−1)). In this regard, the lagging gradients can be inverse proportionally decayed. In another aspect, the gradient management module 528 can determine the weight as r=1/a^{Δ},where “/” indicates division, a is an integer greater than 1 (e.g., a=2), and Δ is the difference between the current iteration index and the iteration index of the lagging gradient set (e.g., t−(t−1)). In this regard, the lagging gradient set can be exponentially decayed.

FIG. 6 illustrates a flowchart of a method 600 that can be performed by a parameter server within the DLTA of FIG. 5, according to some example embodiments. The method 600 includes operations 602, 604, 606, 608, 610, 612, 614, and 616. By way of example and not limitation, the method 600 is described as being performed by the parameter server 502 of FIG. 5.

At operation 602, the parameter server 502 receives a gradient set from worker i. At operation 604, the parameter server 502 determines whether worker i is lagging for the current iteration. If the worker is lagging for the current iteration (i.e., only a lagging gradient is available which is generated for a prior iteration), then at operation 608, a weighted lagging gradient set for worker i is stored by the parameter server 502. If the worker is not lagging for the current iteration, at operation 606, the gradient set for the current iteration for worker i is stored by the parameter server 502. At operation 610, the parameter server 502 can determine whether the total number of gradients received from workers in the current iteration is at least a threshold number of K. If the threshold number of workers K is not yet met, processing can continue at operation 602, with the parameter server waiting for a gradient set from a different worker. If the threshold number of workers K is met, processing continues at operation 612 when the parameter server 502 performs gradient aggregation and averaging to generate an averaged gradient set for the current iteration, using any weighted lagging gradient sets (also referred to as weighted versions of the lagging gradient sets) that have been received as discussed above. At operation 614, the parameter server 502 updates the model parameters using the averaged gradient set. At operation 616, the parameter server makes the updated parameters or the updated model available for the workers to obtain via a pull operation, or the parameter server can communicate such updated parameters for the updated model to the workers.

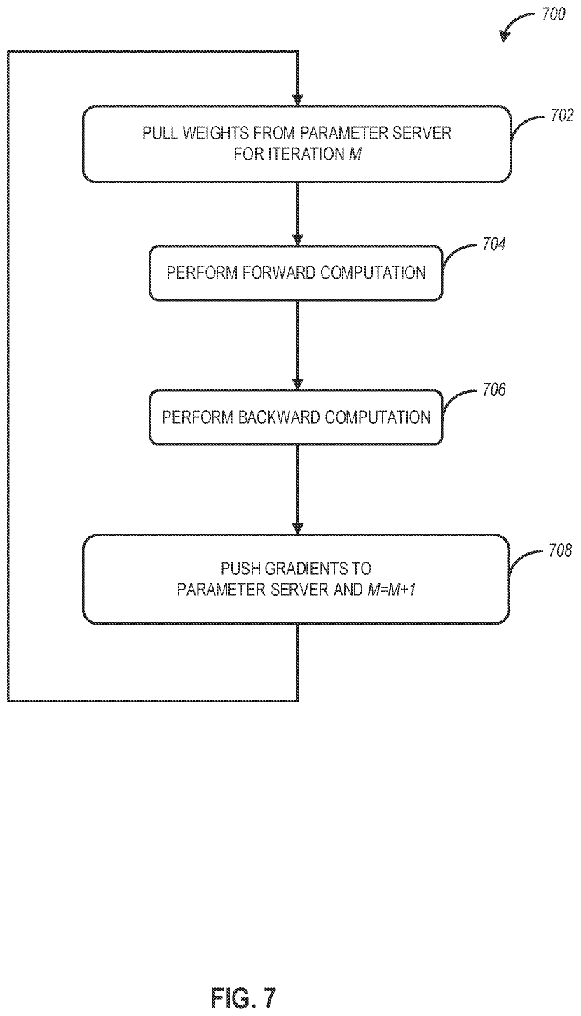

FIG. 7 illustrates a flowchart of a method 700 that can be performed by a worker within the DLTA of FIG. 5, according to some example embodiments. Method 700 includes operations 702, 704, 706, and 708. By way of example and not limitation, method 700 is described as being performed by one of the workers (e.g., worker 504) of FIG. 5.

At operation 702, worker 504 can pull updated parameters such as weights from the parameter server 502 for iteration #M. At operation 704, worker 504 performs forward computation, and at operation 706, worker 504 performs backward computation using the weights received from the parameter server 502. After completion of the forward and backward computations, at operation 708, worker 504 pushes the current gradient set to the parameter server 502 for aggregation and averaging.

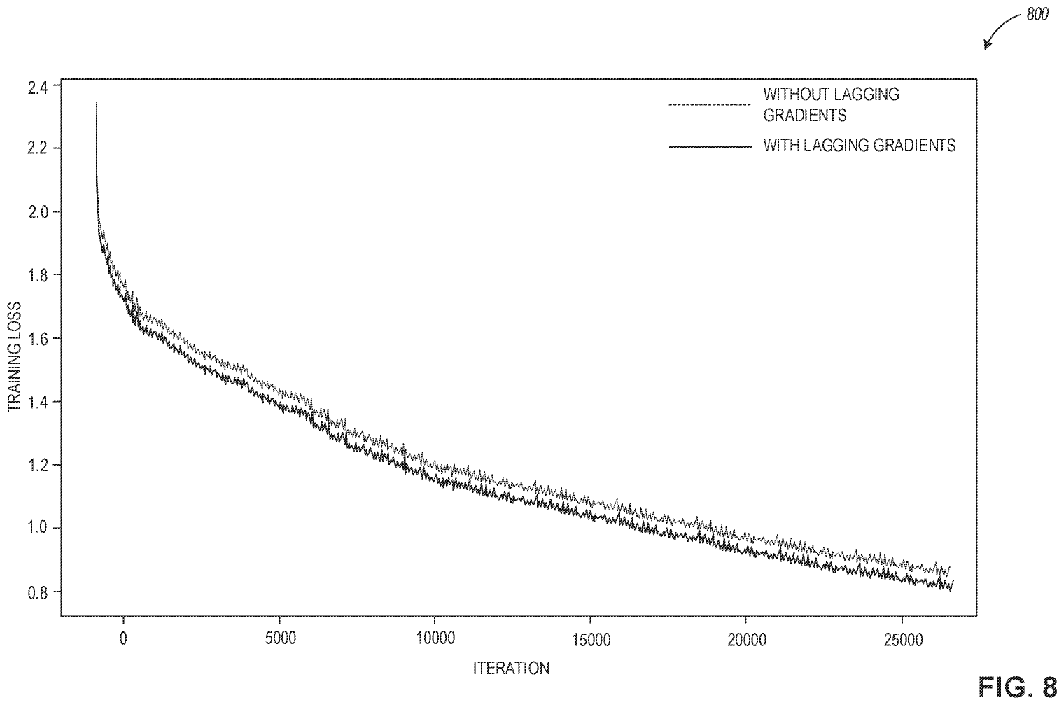

FIG. 8 is a graph 800 illustrating training losses associated with DLTAs that perform gradient aggregation with or without taking into account lagging gradients.

Training loss is a function of measuring the dissimilarity between the output of the network and the ground truth of training labels during the training process. When training deep neural networks for classification, “Cross-Entropy” can be used like the following loss function:

$$- {\sum }_{c = 1}^{M} {y}_{o , c} log ( {p}_{o , c} )$$

where M is a number of classes (e.g., dog, cat, fish, etc.), “log” indicates a natural logarithm, y is a binary indicator (0 or 1) if class label c is the correct classification for observation o, and p is the predicted probability observation o is of class c. When M=2 (binary classification), the loss function can be simplified as follows: −(y log(p)+(1−y) log(1−p)).

As seen in FIG. 8, the training loss is lower when the gradient aggregation and averaging take into account lagging gradients.

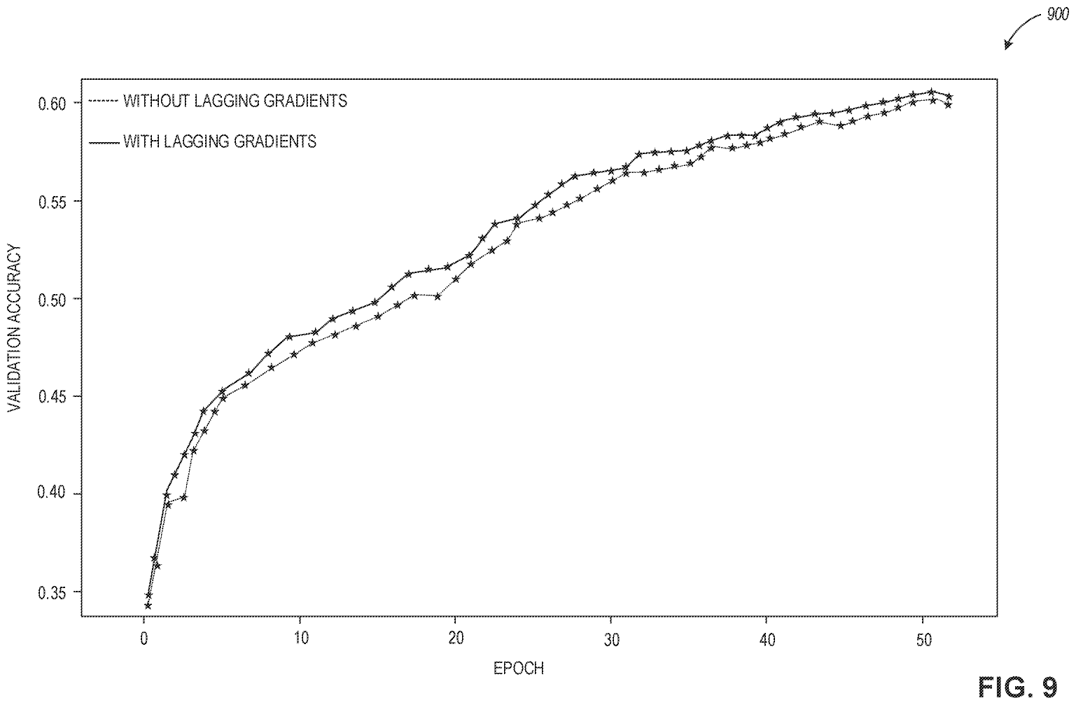

FIG. 9 is a graph 900 illustrating validation accuracy associated with DLTAs that perform gradient aggregation with or without taking into account lagging gradients.

When training a deep neural network, two separate data sets may be used, such as a training set and a validation set. While the network is trained using the training dataset, the performance of the training process is tested using the validation set (since the network may perform significantly better on the training set, but the trained model has to generalize good performance on “unseen data” such as data in the validation set). Validation accuracy is one of the metrics that is used to evaluate the training performance As seen in FIG. 9, the validation accuracy is higher when the gradient aggregation and averaging take into account lagging gradients.

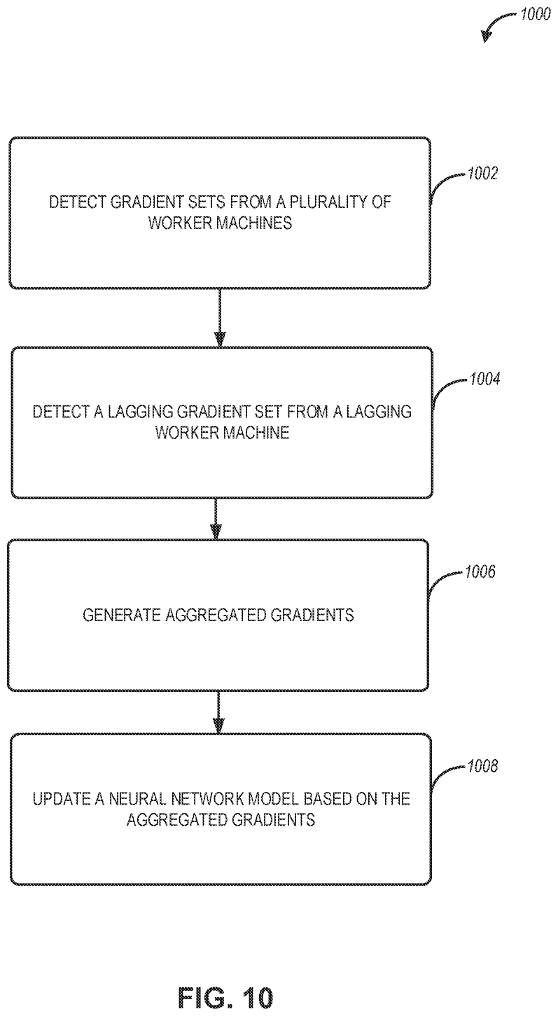

FIG. 10 is a flowchart of a method 1000 for distributed synchronous training of a neural network model within a DLTA, according to some example embodiments. Method 1000 includes operations 1002, 1004, 1006, and 1008. By way of example and not limitation, method 1000 is described as being performed by the parameter server (e.g., 502) or other modules within the DLTA 106.

At operation 1002, a plurality of gradient sets from a corresponding plurality of workers is detected, where each of the workers generates a corresponding gradient set of the plurality of gradient sets in a current iteration of a training data set. For example, the parameter server 502 can detect (or receive via a push operation from the workers) the gradients (or gradient sets) 518 and 520 generated by the workers 504 and 506 during a current iteration #t.

At operation 1004, a lagging gradient set from a lagging worker is detected, where the lagging gradient set is generated by the lagging worker in a prior iteration of the training data set. The lagging worker is a member of the plurality of worker machines. For example, the parameter server 502 can detect (or receive via a push operation from the lagging worker) the lagging gradients (or a lagging gradient set) 522 generated by the lagging worker 508 during a prior iteration #(t−1).

At operation 1006, the parameter server performs gradient aggregation based on the plurality of gradient sets as well as the lagging gradient set to generate aggregated gradients. At operation 1008, the neural network model that is being trained within the DLTA 106 is updated based on the aggregated gradients.

In some aspects, techniques disclosed herein can be used for gradient synchronization that takes place faster than conventional (e.g., serial) gradient synchronization techniques. In this regard, techniques disclosed herein can be used for time-efficient training of machine-learning models in time-sensitive applications, such as self-driving applications or other types of applications that use machine-learning models and need to train or re-train the models in a time-sensitive manner

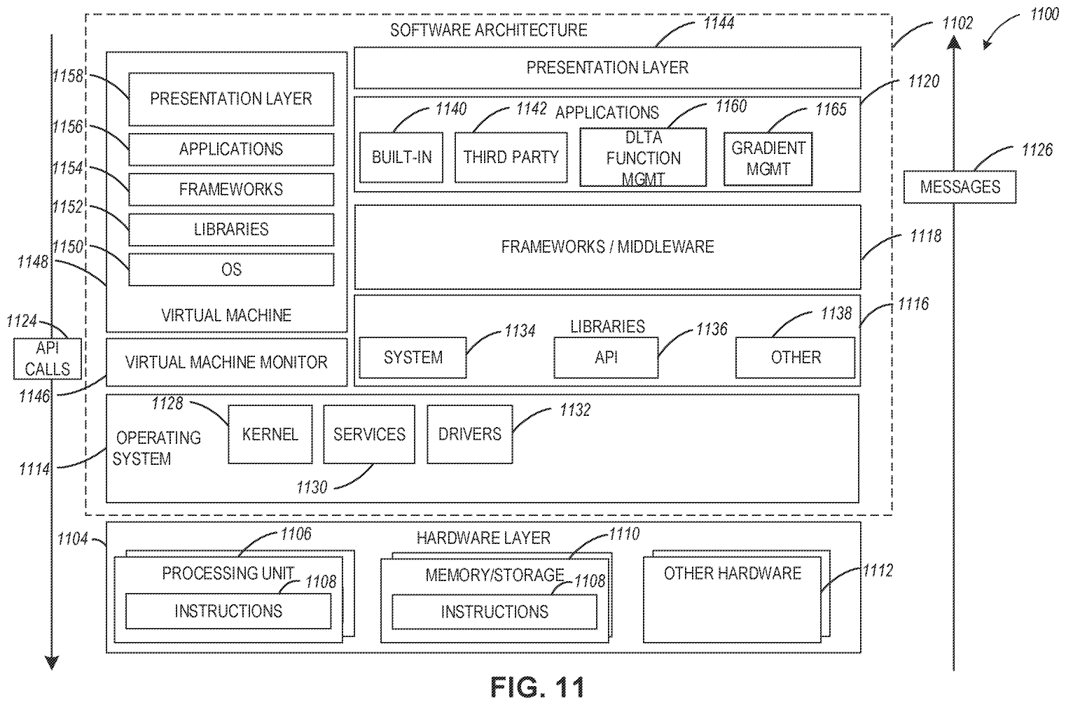

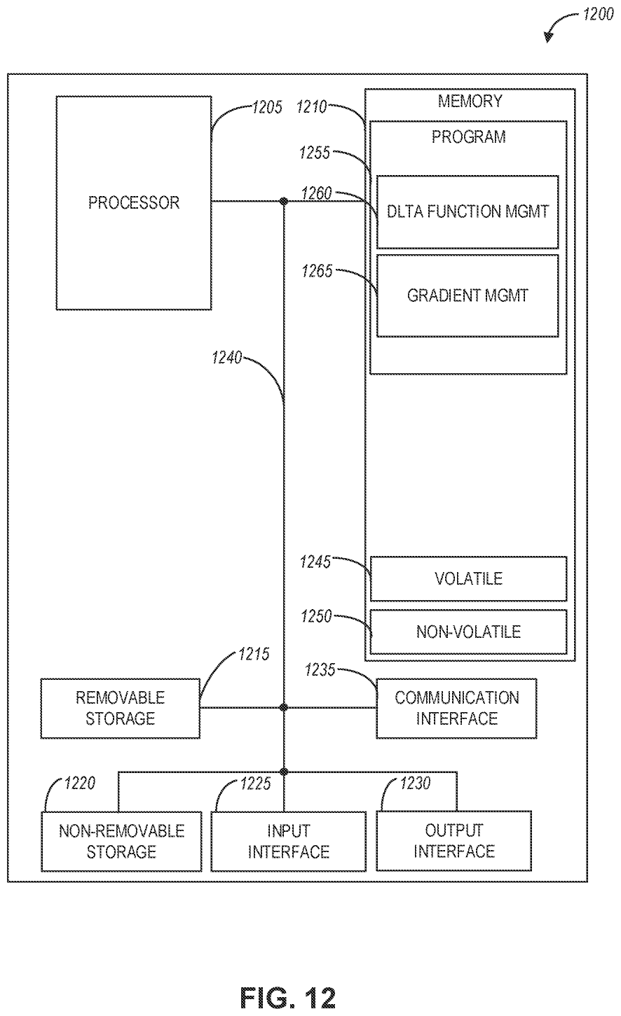

FIG. 11 is a block diagram illustrating a representative software architecture 1100, which may be used in conjunction with various device hardware described herein, according to some example embodiments. FIG. 11 is merely a non-limiting example of a software architecture 1102 and it will be appreciated that many other architectures may be implemented to facilitate the functionality described herein. The software architecture 1102 may be executing on hardware such as device 1200 of FIG. 12 that includes, among other things, processor 1205, memory 1210, removable storage 1215, non-removable storage 1220, and I/O components 1225 and 1230. A representative hardware layer 1104 is illustrated and can represent, for example, the device 1200 of FIG. 12. The representative hardware layer 1104 comprises one or more processing units 1106 having associated executable instructions 1108. Executable instructions 1108 represent the executable instructions of the software architecture 1102, including implementation of the methods, modules, and so forth of FIGS. 1-10. Hardware layer 1104 also includes memory and/or storage modules 1110, which also have executable instructions 1108. Hardware layer 1104 may also comprise other hardware 1112, which represents any other hardware of the hardware layer 1104, such as the other hardware illustrated as part of device 1200.

In the example architecture of FIG. 11, the software architecture 1102 may be conceptualized as a stack of layers where each layer provides particular functionality. For example, the software architecture 1102 may include layers such as an operating system 1114, libraries 1116, frameworks/middleware 1118, applications 1120, and presentation layer 1144. Operationally, the applications 1120 and/or other components within the layers may invoke application programming interface (API) calls 1124 through the software stack and receive a response, returned values, and so forth illustrated as messages 1126 in response to the API calls 1124. The layers illustrated in FIG. 11 are representative in nature and not all software architectures 1102 have all layers. For example, some mobile or special purpose operating systems may not provide frameworks/middleware 1118, while others may provide such a layer. Other software architectures may include additional or different layers.

The operating system 1114 may manage hardware resources and provide common services. The operating system 1114 may include, for example, a kernel 1128, services 1130, and drivers 1132. The kernel 1128 may act as an abstraction layer between the hardware and the other software layers. For example, kernel 1128 may be responsible for memory management, processor management (e.g., scheduling), component management, networking, security settings, and so on. The services 1130 may provide other common services for the other software layers. Drivers 1132 may be responsible for controlling or interfacing with the underlying hardware. For instance, the drivers 1132 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth, depending on the hardware configuration.

Libraries 1116 may provide a common infrastructure that may be utilized by the applications 1120 and/or other components and/or layers. The libraries 1116 typically provide functionality that allows other software modules to perform tasks more easily than to interface directly with the underlying operating system 1114 functionality (e.g., kernel 1128, services 1130, and/or drivers 1132). The libraries 1116 may include system libraries 1134 (e.g., C standard library) that may provide functions such as memory allocation functions, string manipulation functions, mathematic functions, and the like. In addition, the libraries 1116 may include API libraries 1136 such as media libraries (e.g., libraries to support presentation and manipulation of various media formats such as MPEG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 1116 may also include a wide variety of other libraries 1138 to provide many other APIs to the applications 1120 and other software components/modules.

The frameworks/middleware 1118 (also sometimes referred to as middleware) may provide a higher-level common infrastructure that may be utilized by the applications 1120 and/or other software components/modules. For example, the frameworks/middleware 1118 may provide various graphical user interface (GUI) functions, high-level resource management, high-level location services, and so forth. The frameworks/middleware 1118 may provide a broad spectrum of other APIs that may be utilized by the applications 1120 and/or other software components/modules, some of which may be specific to a particular operating system 1114 or platform.

Applications 1120 include built-in applications 1140, third-party applications 1142, a DLTA function management module 1160, and a gradient management module 1165. Examples of representative built-in applications 1140 may include but are not limited to, a contacts application, a browser application, a book reader application, a location application, a media application, a messaging application, and/or a game application. Third-party applications 1142 may include any of the built-in applications 1140 as well as a broad assortment of other applications. In a specific example, the third-party application 1142 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third-party application 1142 may invoke the API calls 1124 provided by the mobile operating system such as operating system 1114 to facilitate the functionality described herein.

In some aspects, the DLTA function management module 1160 and the gradient management module 1165 may comprise suitable circuitry, logic, interfaces, and/or code and can be configured to perform one or more of the functions discussed in connection with modules 526 and 528 of FIG. 5.

The applications 1120 may utilize built-in operating system functions (e.g., kernel 1128, services 1130, and/or drivers 1132), libraries (e.g., system libraries 1134, API libraries 1136, and other libraries 1138), and frameworks/middleware 1118 to create user interfaces to interact with users of the system. Alternatively, or additionally, in some systems, interactions with a user may occur through a presentation layer, such as presentation layer 1144. In these systems, the application/module “logic” can be separated from the aspects of the application/module that interact with a user.

Some software architectures utilize virtual machines. In the example of FIG. 11, this is illustrated by virtual machine 1148. A virtual machine creates a software environment where applications/modules can execute as if they were executing on a hardware machine (such as the device 1200 of FIG. 12, for example). The virtual machine 1148 is hosted by a host operating system (e.g., operating system 1114) and typically, although not always, has a virtual machine monitor 1146, which manages the operation of the virtual machine 1148 as well as the interface with the host operating system (i.e., operating system 1114). A software architecture 1102 executes within the virtual machine 1148 such as an operating system 1150, libraries 1152, frameworks/middleware 1154, applications 1156, and/or presentation layer 1158. These layers of software architecture executing within the virtual machine 1148 can be the same as corresponding layers previously described or may be different.

FIG. 12 is a block diagram illustrating circuitry for a device that implements algorithms and performs methods, according to some example embodiments. All components need not be used in various embodiments. For example, clients, servers, and cloud-based network devices may each use a different set of components, or in the case of servers, larger storage devices.

One example computing device in the form of a computer 1200 (also referred to as computing device 1200, computer system 1200, or computer 1200) may include a processor 1205, memory 1210, removable storage 1215, non-removable storage 1220, input interface 1225, output interface 1230, and communication interface 1235, all connected by a bus 1240. Although the example computing device is illustrated and described as the computer 1200, the computing device may be in different forms in different embodiments.

The memory 1210 may include volatile memory 1245 and non-volatile memory 1250 and may store a program 1255. The computer 1200 may include—or have access to a computing environment that includes—a variety of computer-readable media, such as the volatile memory 1245, the non-volatile memory 1250, the removable storage 1215, and the non-removable storage 1220. Computer storage includes random-access memory (RAM), read-only memory (ROM), erasable programmable read-only memory (EPROM) and electrically erasable programmable read-only memory (EEPROM), flash memory or other memory technologies, compact disc read-only memory (CD ROM), digital versatile disks (DVD) or other optical disk storage, magnetic cassettes, magnetic tape, magnetic disk storage or other magnetic storage devices, or any other medium capable of storing computer-readable instructions.

Computer-readable instructions stored on a computer-readable medium (e.g., the program 1255 stored in the memory 1210) are executable by the processor 1205 of the computer 1200. A hard drive, CD-ROM, and RAM are some examples of articles including a non-transitory computer-readable medium such as a storage device. The terms “computer-readable medium” and “storage device” do not include carrier waves to the extent that carrier waves are deemed too transitory. “Computer-readable non-transitory media” includes all types of computer-readable media, including magnetic storage media, optical storage media, flash media, and solid-state storage media. It should be understood that software can be installed in and sold with a computer. Alternatively, the software can be obtained and loaded into the computer, including obtaining the software through a physical medium or distribution system, including, for example, from a server owned by the software creator or from a server not owned but used by the software creator. The software can be stored on a server for distribution over the Internet, for example. As used herein, the terms “computer-readable medium” and “machine-readable medium” are interchangeable.

Program 1255 may utilize a customer preference structure using modules discussed herein, such as the DLTA function management module 1260 and the gradient management module 1265, which may be the same as modules 526 and 528 discussed in connection with FIG. 5.

Any one or more of the modules described herein may be implemented using hardware (e.g., a processor of a machine, an application-specific integrated circuit (ASIC), field-programmable gate array (FPGA), or any suitable combination thereof). Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

In some aspects, modules 1260 and 1265, as well as one or more other modules that are part of the program 1255, can be integrated as a single module, performing the corresponding functions of the integrated modules.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

It should be further understood that software including one or more computer-executable instructions that facilitate processing and operations as described above with reference to any one or all of the disclosed functionalities can be installed in and sold with one or more computing devices consistent with the disclosure. Alternatively, the software can be obtained and loaded into one or more computing devices, including obtaining the software through a physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components outlined in the description or illustrated in the drawings. The embodiments herein are capable of other embodiments and capable of being practiced or carried out in various ways. Also, it will be understood that the phraseology and terminology used herein is for description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled,” and variations thereof, are not restricted to physical or mechanical connections or couplings. Further, terms such as up, down, bottom, and top are relative, and are employed to aid illustration, but are not limiting.

The components of the illustrative devices, systems, and methods employed in accordance with the illustrated embodiments can be implemented, at least in part, in digital electronic circuitry, analog electronic circuitry, or computer hardware, firmware, software, or in combinations of them. These components can be implemented, for example, as a computer program product such as a computer program, program code or computer instructions tangibly embodied in an information carrier, or a machine-readable storage device, for execution by, or to control the operation of, data processing apparatus such as a programmable processor, a computer, or multiple computers.

A computer program can be written in any form of programming language, including compiled or interpreted languages, and it can be deployed in any form, including as a stand-alone program or as a module, component, subroutine, or other units suitable for use in a computing environment. A computer program can be deployed to be executed on one computer or multiple computers at one site or distributed across multiple sites and interconnected by a communication network. Also, functional programs, codes, and code segments for accomplishing the techniques described herein can be easily construed as within the scope of the claims by programmers skilled in the art to which the techniques described herein pertain. Method steps associated with the illustrative embodiments can be performed by one or more programmable processors executing a computer program, code, or instructions to perform functions (e.g., by operating on input data and/or generating an output). Method steps can also be performed by, and apparatus for performing the methods can be implemented as, special purpose logic circuitry, e.g., an FPGA (field-programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, an FPGA or other programmable logic device, discrete gate, or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random-access memory or both. The required elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

As used herein, “machine-readable medium” (or “computer-readable medium”) means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium or a combination of multiple media, that is capable of storing instructions for execution by one or more processors (e.g., processor 1205), such that the instructions, when executed by one or more processors, cause the one or more processors to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” as used herein excludes signals per se.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the scope disclosed herein.

Although the present disclosure has been described with reference to specific features and embodiments thereof, it is evident that various modifications and combinations can be made thereto without departing from the scope of the disclosure. For example, other components may be added to, or removed from, the described systems. The specification and drawings are, accordingly, to be regarded simply as an illustration of the disclosure as defined by the appended claims, and are contemplated to cover any modifications, variations, combinations, or equivalents that fall within the scope of the present disclosure. Other aspects may be within the scope of the following claims.

What is claimed is:

1. A computer-implemented method for distributed synchronous training of a neural network model, the method comprising:
detecting gradient sets from a plurality of worker machines, each worker machine generating a gradient set in a current iteration of a training data set, and each gradient set of the gradient sets comprising a plurality of gradients;
detecting a lagging gradient set from a lagging worker machine, the lagging gradient set generated by the lagging worker machine in a prior iteration of the training data set;
generating aggregated gradients by performing gradient aggregation based on the gradient sets and the lagging gradient set; and
updating the neural network model based on the aggregated gradients.

2. The computer-implemented method of claim 1, further comprising:
averaging the aggregated gradients to generate an averaged gradient set; and
updating a plurality of weights of the neural network model using the averaged gradient set.

3. The computer-implemented method of claim 1, further comprising:
determining a lagging gradient set weight for the lagging gradient set; and
performing the gradient aggregation using the plurality of gradient sets and the lagging gradient set weight.

4. The computer-implemented method of claim 3, wherein the lagging gradient set weight is determined based on an index of the current iteration and an index of the prior iteration.

5. The computer-implemented method of claim 4, wherein the lagging gradient set weight is 1/(1+Δ), where Δ is a difference between the index of the current iteration and the index of the prior iteration.

6. The computer-implemented method of claim 4, wherein the lagging gradient set weight is 1/a^{Δ}, where Δis a difference between the index of the current iteration and the index of the prior iteration and a is an integer greater than 1.

7. The computer-implemented method of claim 1, further comprising:
performing the gradient aggregation when a number of worker machines of the plurality of worker machines from which gradient sets of the plurality of gradient sets are received reaches a threshold number of worker machines.

8. The computer-implemented method of claim 1, further comprising:
updating a plurality of weights and biases within the neural network model based on the aggregated gradients.

9. The computer-implemented method of claim 1, further comprising:
receiving the plurality of gradient sets from the plurality of worker machines via corresponding push operations, subsequent to completion of forward compute and backward compute operations at each worker machine of the plurality of worker machines during the current iteration.

10. A distributed synchronous training system for training a neural network model, the system comprising:
a memory storing instructions; and
one or more processors in communication with the memory, the one or more processors executing the instructions to:
detect gradient sets from a plurality of worker machines, each worker machine generating a gradient set in a current iteration of a training data set, and each gradient set of the gradient sets comprising a plurality of gradients;
detect a lagging gradient set from a lagging worker machine, the lagging gradient set generated by the lagging worker machine in a prior iteration of the training data set;
generate aggregated gradients by performing gradient aggregation based on the gradient sets and the lagging gradient set; and
update the neural network model based on the aggregated gradients.

11. The system of claim 10, wherein the one or more processors execute the instructions to:
average the aggregated gradients to generate an averaged gradient set; and
update a plurality of weights of the neural network model using the averaged gradient set.

12. The system of claim 10, wherein the one or more processors execute the instructions to:
determine a lagging gradient set weight for the lagging gradient set; and
perform the gradient aggregation using the plurality of gradient sets and the lagging gradient set weight.

13. The system of claim 12, wherein the lagging gradient set weight is determined based on an index of the current iteration and an index of the prior iteration.

14. The system of claim 13, wherein the lagging gradient set weight is 1/(1+Δ), where Δ is a difference between the index of the current iteration and the index of the prior iteration.

15. The system of claim 13, wherein the lagging gradient set weight is 1/a^{Δ}, where Δ is a difference between the index of the current iteration and the index of the prior iteration, and a is an integer greater than 1.

16. The system of claim 10, wherein the one or more processors execute the instructions to:
perform the gradient aggregation when a number of worker machines of the plurality of worker machines from which gradient sets of the plurality of gradient sets are received reaches a threshold number of worker machines.

17. The system of claim 16, wherein the one or more processors execute the instructions to:
update a plurality of weights and biases within the neural network model based on the aggregated gradients.

18. A non-transitory computer-readable medium storing computer instructions for training a neural network model, wherein the instructions when executed by one or more processors, cause the one or more processors to perform steps of:
detecting gradient sets from a plurality of worker machines, each worker machine generating a gradient set in a current iteration of a training data set, and each gradient set of the gradient sets comprising a plurality of gradients;
detecting a lagging gradient set from a lagging worker machine, the lagging gradient set generated by the lagging worker machine in a prior iteration of the training data set;
generating aggregated gradients by performing gradient aggregation based on the gradient sets and the lagging gradient set; and
updating the neural network model based on the aggregated gradients.

19. The non-transitory computer-readable medium of claim 18, wherein the instructions further cause the one or more processors to perform steps of:
averaging of the aggregated gradients to generate an averaged gradient set; and
updating a plurality of weights of the neural network model using the averaged gradient set.

20. The non-transitory computer-readable medium of claim 18, wherein the instructions further cause the one or more processors to perform steps of:
determining a lagging gradient set weight for the lagging gradient set; and
performing the gradient aggregation using the plurality of gradient sets and the lagging gradient set weight.
